(19) United States
(12) Patent Application Publication
(10) Pub. No.: US 2006/0196617 A1
(43) Pub. Date: Sep. 7, 2006

(54) Sound absorbing composite blind systems

(76) Inventors: Arthur P. Barkman, Hillsborough, NJ (US); Michael Kemp, Pittstown, NJ (US)

Correspondence Address: Kenneth P. Glynn, 24 Mine Street, Flemington, NJ, 08822, US

(21) Appl. No.: 11/071,813

(22) Filed: Mar. 3, 2005

(51) Int. Cl. E06B 3/12

(52) U.S. Cl. 160/236

(57) ABSTRACT

The sound absorbing composite blind system includes a support for a plurality of window blinds and an operational mechanism connected to the support and to the window blinds for opening and closing the window blinds. Each blind is adapted for sound absorption, made of a composite of at least three layers of material, having a noise reduction coefficient (ARC) of at least 0.60 when the blinds are closed. The layers include (i) an acoustically porous decorative facing layer; (ii) one or more intermediate insulative absorptive layers; and, (iii) a backing layer. The intermediate insulative absorptive layer(s) may be a glass fiber, organic or inorganic mat, or a foam layer.

### BACKGROUND OF THE INVENTION

1. Field of the Invention

The present invention relates to window blinds, doorway blinds, divider blinds and other blinds that are opened and closed to permit/prevent light entry and/or create/remove privacy. More specifically, the present invention relates to blind systems of the above types wherein these blinds systems advantageously absorb sound to decrease echoing, reverberations, distortion, etc. in the surrounding environments.

2. Information Disclosure Statement

The following patents represent the prior art pertaining to various blind systems.

U.S. Pat. No. 4,884,615 to Henry C. Hsu describes a slat for use in the assembly of a Venetian blind that is provided with a light and sound absorptive coating on at least one if its major surfaces produced by flecking, applique, or textile weaving techniques, a preferred embodiment of the invention providing a strip having enhanced resistance to slippage of a coating appliqued to the strip and of a textile encapsulation of the strip in directions laterally and longitudinally of the strip.

U.S. Pat. No. 6,446,751 to Krishan K. Ahuja et al. describes a flexible sound shielding curtain that contains a plurality of sound insulating sheet inserts encased within pockets or otherwise secured on the exterior surfaces of the panels of a curtain. The sound insulating sheet inserts may be constructed of a combination of materials selected and configured such that sound impinging upon the curtain is absorbed or alternatively reflected. The sound shielding curtain can be tuned to insulate an area from a select range of frequencies inherent in select environments. Turning may be accomplished through the selection and installation of sound insulating sheet inserts configured to reflect or absorb audible acoustical energy. The sound insulating sheet inserts are readily removable to permit periodic laundering of the curtain fabric and to provide adaptability for a number of applications. Sound shielding curtain(s) can be selected, configured, installed, and extended in such a manner as to provide sound reduction in a localized space. The sound shielding curtain(s) may also be configured with a view window by replacing a portion of one or more sound insulating sheets with an acoustically hard transparent material. The acoustically hard material may also comprise a panel of controllable privacy film.

U.S. Pat. No. 6,615,951 to Claude Boutin et al. describes an invention that concerns an absorbent material consisting of a porous matter with open porosity characterized in that in comprises a plurality of perforations with varied transverse cross-section end positioned at an angle relative to a specific dimension of the material, thereby providing additional porosity to the material.

Notwithstanding the prior art, the present invention is neither taught nor rendered obvious thereby.

### SUMMARY OF THE INVENTION

The present invention sound absorbing composite blind system includes: (a) support means for a plurality of window blinds; (b) operational means connected to the support means and to the plurality of window blinds for opening and closing the window blinds; and, (c) the plurality of window blinds connected to the support means and the operational means. Each of the plurality of window blinds are adapted for sound absorption, and each of the plurality of window blinds are made of a composite of at least three layers of material, having a noise reduction coefficient of at least 0.60 when the plurality of blinds are closed, including: (i) an acoustically porous decorative facing layer; (ii) an intermediate insulative absorptive layer; and, (iii) a backing layer.

The present invention sound absorbing composite blind system wherein the intermediate insulative absorptive layer may be a fiber glass layer selected from the group consisting of compression molded fiber glass, spun fiber glass and swirled mat fiber glass. Alternatively, the sound absorbing composite blind system intermediate insulative absorptive layer may be a foam layer. Preferably, the foam layer is selected from the group consisting of at least partially open pore urethane foam and at least partially open pore polyester foam. As another alternative, the intermediate insulative absorptive layer may be a mat layer selected from the group consisting of inorganic mat, organic mat and combinations thereof.

In some embodiments of the present invention, the sound absorbing composite blind system has blinds with at least two diverse intermediate insulative absorptive layers.

In these embodiments, with two or more center layers, at least one of the intermediate insulative absorptive layers may be a fiber glass layer selected from the group consisting of compression molded fiber glass, spun fiber glass and swirl mat fiber glass. Alternatively, there is a foam layer intermediate insulative absorptive layer wherein the foam layer is selected from the group consisting of at least partially open pore urethane foam and at least partially open pore polyester foam. As another alternative, wherein two or more intermediate insulative absorptive layers are included in the blinds, one such layer may be a mat layer selected from the group consisting of inorganic mat, organic mat and combinations thereof.

The present invention sound absorbing composite blind system plurality of blinds may have blinds that include two opposing elongated enclosure channels that receive and hold peripheral edges of the blind. In some embodiments, these elongated enclosure channels are channels having cross-sections selected from the group consisting of three right angled sides and arcuated.

The present invention sound absorbing composite blind system intermediate insulative absorptive layer has a thickness of about 0.15 inches to about 1 inch and preferably about 0.15 inches to about 0.5 inches. The intermediate insulative absorptive layer may have a density of about 4 pounds per cubic foot to about 9 pounds per cubic foot.

The present invention sound absorbing composite blind system plurality of blinds may be vertical blinds, horizontal blinds, or angled blinds that are neither vertical nor horizontal.

### BRIEF DESCRIPTION OF THE DRAWINGS

The present invention should be more fully understood when the specification herein is taken in conjunction with the drawings appended hereto wherein:

FIG. 1 shows a partial cut, front view of one embodiment of a present invention sound absorbing composite blind system;

FIG. 2 shows a top cut view of one preferred blind used in a present invention sound absorbing composite blind system;

FIGS. 3 and 4 show top cut and top cut partial views, respectively, of various present invention sound absorbing blinds;

FIGS. 5 and 6 show front views of alternative embodiments of present invention sound absorbing composite blind systems; and,

FIGS. 7 and 8 show graphic test results for noise reduction coefficients of a present invention sound absorbing composite blind system.

### DETAILED DESCRIPTION OF THE PRESENT INVENTION

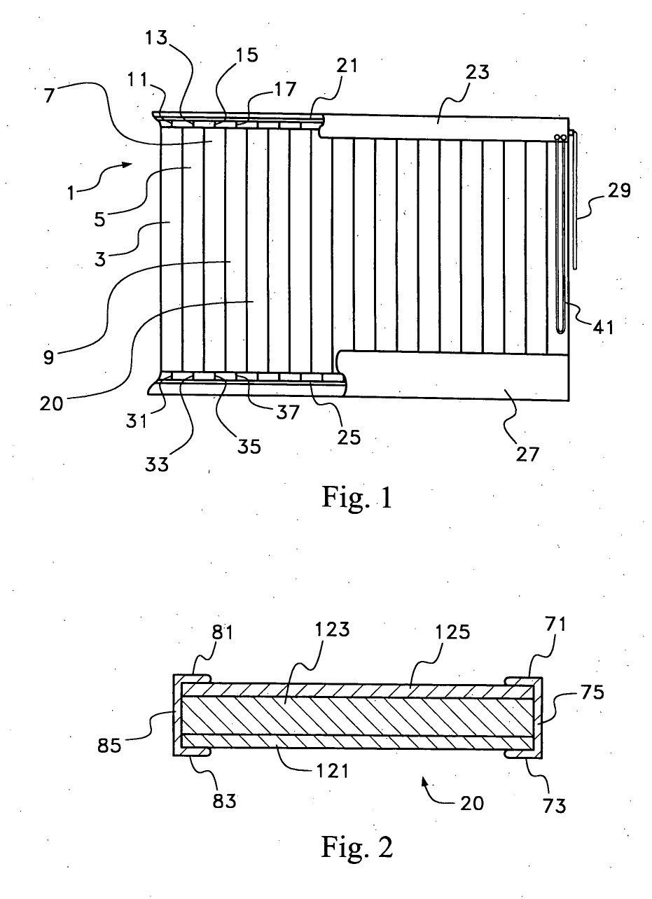

FIG. 1 shows a partial cut, front view of a present invention sound absorbing composite blind system 1. It includes a plurality of individual vertical blinds, e.g., 3, 5, 7, 9 and 20. These blinds are mounted in a frame that has a horizontal top housing 23 and an optional horizontal bottom housing 27, with tracks 21 and 25, respectively. Each blind has an upper fittage that comprises a vertical attachment connected to a track support that may be slid left to right and right to left on the tracks and may be rotated. These may be any of a number of known system supports used with conventional vertical blinds the details of which are within the purview of the artisan. Thus blinds 3, 5, 7 and 9, for example, have upper vertical attachment fittage 11, 13, 15 and 17 respectively, and optional lower vertical attachment fittages 31, 33, 35 and 37, respectively. A user would rotate rod 29 to rotate the blinds by these fittages for stationary (fixed axis) opening and closing, and would pull on the one side or the other of cord 41 to slide open and to slide close these blinds along the track (linear movement).

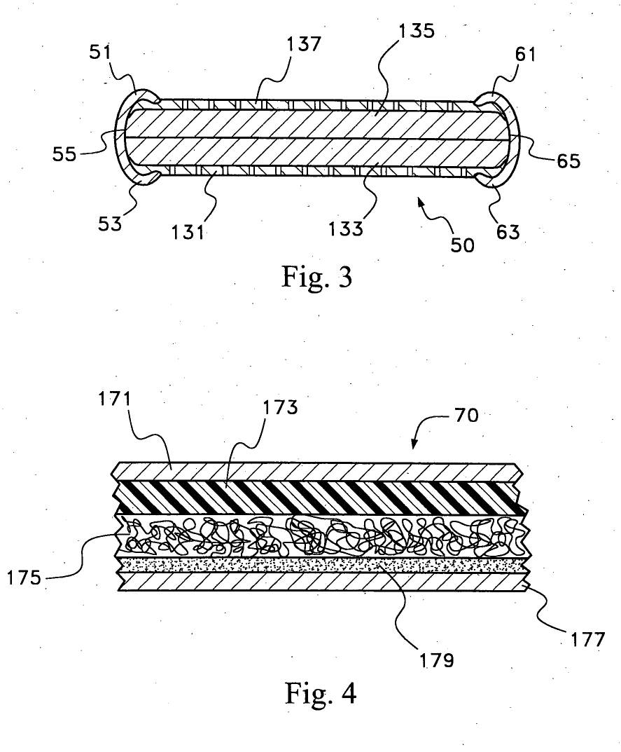

FIG. 2 shows a top cut view of one preferred blind used in a present invention sound absorbing composite blind system 1 shown in FIG. 1. FIG. 2 thus shows slide 20 from system 1 in FIG. 1, in a top cut view. There are three layers of material cut in elongated rectangular shape, stacked and crimped in place. Front layer 121 is an acoustically porous decorative facing layer that is at least 22% open. This is the layer that faces into a room and has some type of decorative aspect-topography, color, design, weave, etc. that is aesthetically acceptable. More importantly, this layer must be at least 22% porous. This is typically a fabric that is perforated, woven, or both. Polyesters, nylons, dacrons, cottons, cotton blends, linens, etc. may be used as long as they have sufficient porosity.

Behind the front layer 121 is the middle layer which is the intermediate insulative absorptive layer 123. In this embodiment, it is a single layer, but, as described below, it may be a plurality of intermediate layers or a single layer of mixed diverse materials. Layer 123, here, is a compression molded mat of glass fibers with phenolic resins (e.g. phenol formaldehyde) commonly known as fiber glass. This material has a density of about 5 pounds per cubic foot to about 9 pounds per cubic foot. Other materials, such as those that are described in the summary above, could be substituted for the mat. The material is usually semi-flexible but may stand on its own like a foam or cardboard.

The backing layer 125 faces outward and may be of the same or different material as the front layer 121, but is preferably chosen from the same field or type of material as the front layer. In other preferred embodiments, the backing layer may be a barrier layer that will function to prevent external sound from entering the room. Further, when the blinds are reversed, they will function to reflect rather than absorb sound.

The three layers 121, 123 and 125 are supported by a frame in the form of side and top and bottom enclosure channels. In this FIG. 2, the enclosure channels 75 and 85 are shown and these have right angled ends 71 and 73, and 81 and 83, respectively, to hold the layers in place.

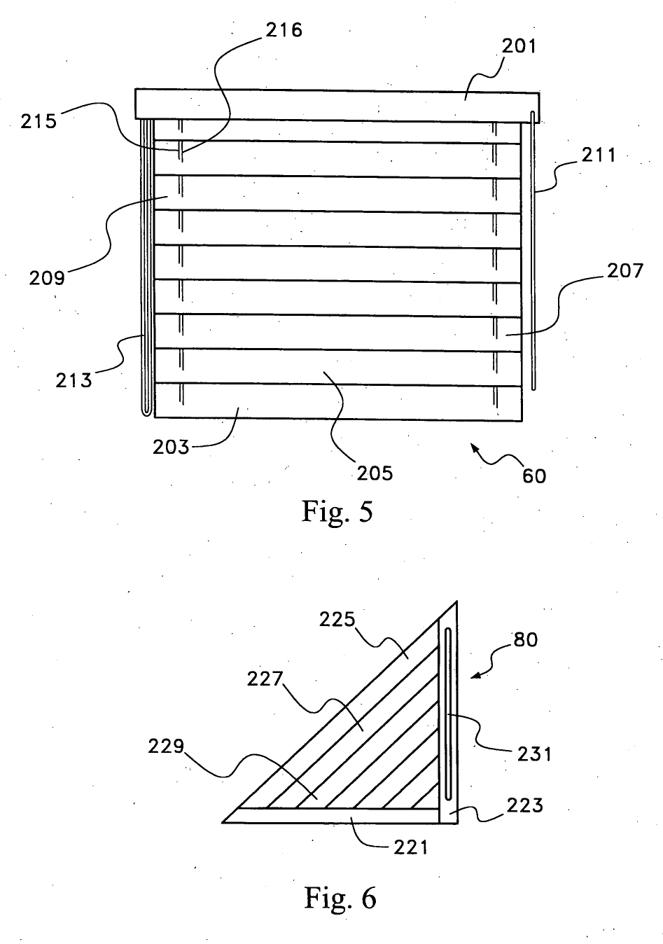

FIGS. 3 and 4 show top cut and top cut partial views respectively, of various alternative present invention sound absorbing blinds.

FIG. 3 shows a top cut view of present invention blind 50. It has a facing layer 131, two intermediate layers 133 and 135, layer 133 being a partially open pore polyurethane semi-flexible foam, and layer 135 being a felt mat. Facing layer 131 and backing layer 137 are made of perforated fabric. Facing layer 131 has a printed design for a decorative facade.

FIG. 4 shows present invention blind 70 with three layers in the middle. Facing layer 177 is a woven fabric; intermediate layer 175 is a spun glass fiber mat and intermediate layer 173 is a semi-porous polyester foam layer. There is a backing layer 171 similar to those described above.

All of the blinds shown and described in the Figures above have a noise reduction coefficient of over 0.65. (Noise reduction coefficient is the average of the coefficients measured at 250, 500, 1000 and 2000 Hz.)

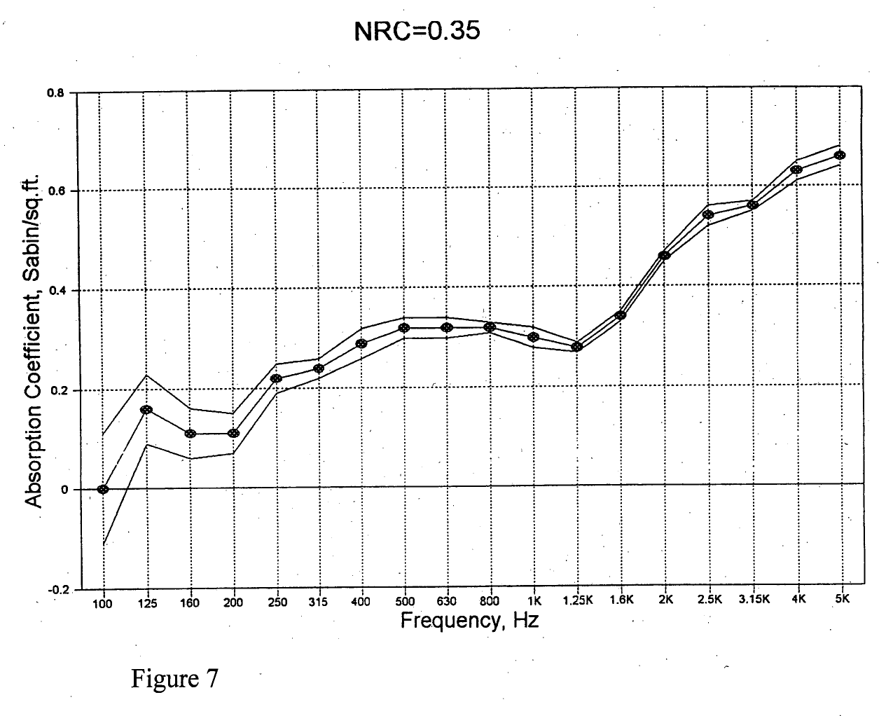

FIGS. 5 and 6 show front views of alternative present invention sound absorbing composite blind systems. FIG. 5 shows a horizontal blind system 60 with horizontal blinds 203, 205, 207, 209, etc. There is an optional top housing 201 (and no bottom housing) with connecting lines such as lines 215 and 216 that connect inside housing 201 to permit opening and closing and raising and lowering of the blinds. The cord 213 is used for raising and lowering, and the rod 211 is twisted for opening and closing the blinds on a fixed axis. The blinds themselves are of the type shown in FIG. 3.

FIG. 6 shows present invention blind system 8—for a right triangle window. These do not slide but only rotate. The blinds 225, 227, 229, etc. have connections inside horizontal housing 221 and vertical housing 231 and are rotated in plane to open and close, by rotation of rod 231. These blinds have a construction as shown in FIG. 4.

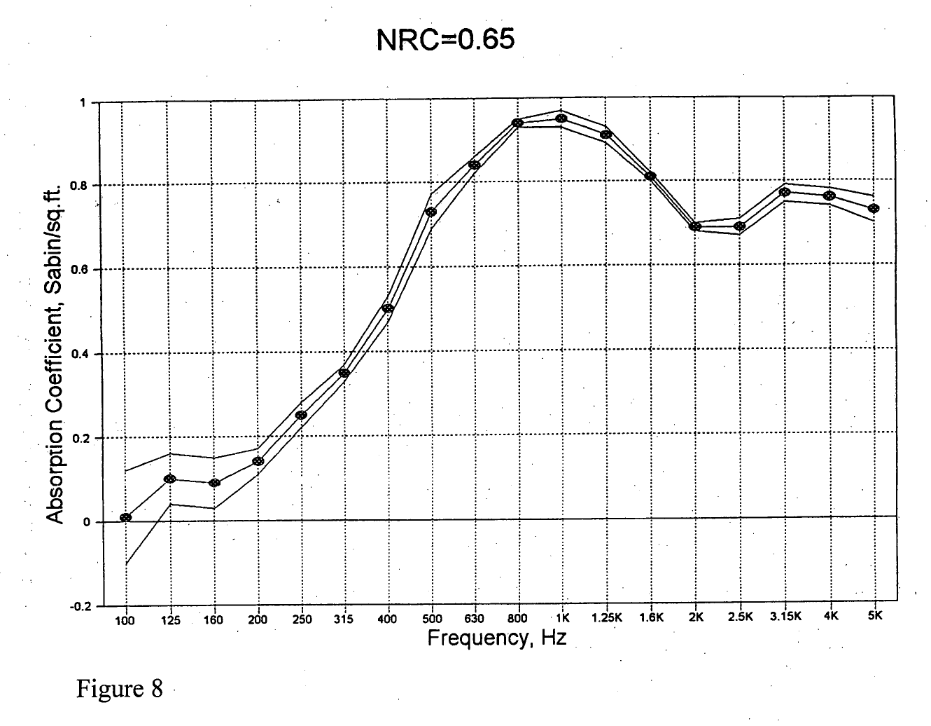

FIGS. 7 and 8 show graphic test results for noise reduction coefficients of a present invention sound absorbing composite blind system shown in FIGS. 1 and 2. These test were conducted on a window with measurements from inside a room.

The sound adsorption coefficient of a surface in a specified frequency band is, aside from the effects of diffraction, the fraction of randomly incident sound energy absorbed or otherwise not reflected. The unit of measurement is Sabin per square foot.

The noise reduction coefficient, NRC, is the average of the sound absorption coefficients at 250, 500, 1000 and 2000 Hz expressed to the nearest integral multiple of 0.05. Measurements were made according to: ASTM Designation: C 423-90g, “Standard Test Method for Sound Absorption and Sound Absorption Coefficients by the Reverberation Room Method.” Standard Mountings are defined in: ASTM Designation: E 795-91, “Standard Practices for Mounting Test Specimens During Sound Absorption Test.”

The test specimen consisted of 48 vertical blind strips. Each strip was 3¾″ wide by 71¼″ long by ¼″ thick. The strips were mounted in channels as described above. The mounting fixture consisted of three wooden frames enclosed on four sides. Each frame's inside dimensions were 48″ by 72″. The three frames were placed against the test room wall adjacent each other, forming a continuous test specimen 6′ high and 12′ wide. The vertical blind strips were hung on 3″ centers from cup hooks screwed into the top of each wooden frame. The line along which the cup hooks were secured was 2⅝″ from the test wall surface. The cracks between the top rear edges of the wooden frames and the test surface was sealed with duct tape to prevent sound from entering from the top. The blind strips were positioned in the open configuration, at a 90° angle from the test surface, and subsequently in the fully closed position.

The specimen, identified as “Vertical Blind Strips” was submitted for testing by Arthur Barkman. The weight of the specimen was 23.5 pounds. The area used to calculate absorption coefficients was 72 square feet, the face area of the specimen.

The calculated values of the sound absorption of the specimen and sound absorption coefficients together with the calculated measurement uncertainty for each are tabulated in Tables 1 and 2 below for open and closed blinds, respectively. FIGS. 7 and 8 show the results graphically for open and closed blinds. Point dots are data points and upper and lower lines on these graphs are deviation lines. Results were more than double the NRC of standard blinds.

TABLE 1
PRESENT INVENTION BLINDS OPEN

| Frequency | Absorption | | Coefficient | |
|---|---|---|---|---|
| (Hz) | (Sabin) | Deviation | (Sabin/ft²) | Deviation |
| 100 | 0 | 8.1 | 0 | 0.11 |
| 126 | 11.4 | 4.7 | 0.16 | 0.07 |
| 160 | 7.9 | 3.8 | 0.11 | 0.05 |
| 200 | 7.6 | 2.6 | 0.11 | 0.04 |
| 250 | 15.6 | 2.5 | 0.22 | 0.03 |
| 315 | 17.2 | 1.7 | 0.24 | 0.02 |
| 400 | 21.2 | 2.2 | 0.29 | 0.03 |
| 500 | 22.9 | 1.5 | 0.32 | 0.02 |
| 630 | 22.9 | 1.3 | 0.32 | 0.02 |
| 800 | 23.2 | 1 | 0.32 | 0.01 |
| 1K | 21.3 | 1.2 | 0.3 | 0.02 |
| 1.25K | 20.2 | 1 | 0.28 | 0.01 |
| 1.6K | 24.0 | 0.7 | 0.34 | 0.01 |
| 2K | 32.9 | 0.7 | 0.46 | 0.01 |
| 2.5K | 38.6 | 1.3 | 0.54 | 0.02 |
| 3.15K | 40.3 | 1.1 | 0.56 | 0.01 |
| 4K | 45.5 | 1.7 | 0.63 | 0.02 |
| 5K | 47.8 | 1.7 | 0.66 | 0.02 |

| | |
|---|---|
| Noise Reduction Coefficient (NRC) | 0.35 |

TABLE 2
PRESENT INVENTION BLINDS CLOSED

| Frequency | Absorption | | Coefficient | |
|---|---|---|---|---|
| (Hz) | (Sabin) | Deviation | (Sabin/ft²) | Deviation |
| 100 | 0.7 | 8.2 | 0.01 | 0.11 |
| 126 | 6.9 | 4.6 | 0.1 | 0.06 |
| 160 | 6.6 | 4.2 | 0.09 | 0.06 |
| 200 | 10.1 | 2.2 | 0.14 | 0.03 |
| 250 | 17.9 | 2 | 0.25 | 0.03 |
| 315 | 25.3 | 1.5 | 0.35 | 0.02 |
| 400 | 36.3 | 1.9 | 0.5 | 0.03 |
| 500 | 52.3 | 2.6 | 0.73 | 0.04 |
| 630 | 60.7 | 1.2 | 0.84 | 0.02 |
| 800 | 67.9 | 1.1 | 0.94 | 0.01 |
| 1K | 68.5 | 1.3 | 0.95 | 0.02 |
| 1.25K | 65.8 | 1.3 | 0.91 | 0.02 |
| 1.6K | 58.1 | 1 | 0.81 | 0.01 |
| 2K | 49.9 | 1 | 0.69 | 0.01 |
| 2.5K | 49.6 | 1.2 | 0.69 | 0.02 |
| 3.15K | 55.4 | 1.3 | 0.77 | 0.02 |
| 4K | 55.4 | 1.3 | 0.76 | 0.02 |
| 5K | 52.8 | 2.2 | 0.73 | 0.03 |

| | |
|---|---|
| Noise Reduction Coefficient (NRC) | 0.65 |

The present invention blind systems offer the user/designer the opportunity to create arrangements with a selection of materials of construction, shapes and sizes, and eliminate the need for rigid extruded plastic or metal blinds or blind substrates previously used, while providing increased sound absorption. The later advantageous present invention characteristic will be beneficial to both decrease sound reflection and decrease sound distortion, as has historically occurred in meetings, videoconferencing, teleconferencing and other interior space. Prior to the use of the present invention systems, the largest source of untreatable sound reverberation and distortion (through additive and canceling effects of original and echoing sound waves) in meeting rooms and conferencing rooms has been window areas, including conventional window areas, even with conventional blinds closed! These problems have been significantly reduced with the present invention blind systems.

While appearing the same as traditional blinds, the present invention blinds provide for absorption of 65% of incident noise (over 85% in the articulate speech frequency range) when closed and 35% absorption (over 40% in the articulate speech frequency range) when open.

Obviously, numerous modifications and variations of the present invention are possible in light of the above teachings. It is therefore understood that within the scope of the appended claims, the invention may be practiced otherwise than as specifically described herein.

What is claimed is:

1. A sound absorbing composite blind system, which comprises:
(a) support means for a plurality of window blinds;
(b) operational means connected to said support means and to said plurality of window blinds for opening and closing said window blinds; and,
(c) said plurality of window blinds connected to said support means and said operational means, each of said plurality of window blinds being adapted for sound absorption, and each of said plurality of window blinds being a composite of at least three layers of material, having a noise reduction coefficient of at least 0.60 when said plurality of blinds are closed, including:
(i) an acoustically porous decorative facing layer;
(ii) an intermediate insulative absorptive layer; and,
(iii) a backing layer.

2. The sound absorbing composite blind system of claim 1 wherein said intermediate insulative absorptive layer is a fiber glass layer selected from the group consisting of compression molded fiber glass, spun fiber glass and swirled mat fiber glass.

3. The sound absorbing composite blind system of claim 1 wherein said intermediate insulative absorptive layer is a foam layer.

4. The sound absorbing composite blind system of claim 3 wherein said foam layer is selected from the group consisting of at least partially open pore urethane foam and at least partially open pore polyester foam.

5. The sound absorbing composite blind system of claim 1 wherein said intermediate insulative absorptive layer is a mat layer selected from the group consisting of inorganic mat, organic mat and combinations thereof.

6. The sound absorbing composite blind system of claim 1 wherein there are at least two diverse intermediate insulative absorptive layers.

7. The sound absorbing composite blind system of claim 6 wherein at least one of said intermediate insulative absorptive layers is a fiber glass layer selected from the group consisting of compression molded fiber glass, spun fiber glass and swirled mat fiber glass.

8. The sound absorbing composite blind system of claim 6 wherein at least one of said intermediate insulative absorptive layers is a foam layer.

9. The sound absorbing composite blind system of claim 8 wherein said foam layer is selected from the group consisting of at least partially open pore urethane foam and at least partially open polyester foam.

10. The sound absorbing composite blind system of claim 6 wherein said intermediate insulative absorptive layer is a mat layer selected from the group consisting of inorganic mat, organic mat and combinations thereof.

11. The sound absorbing composite blind system of claim 1 wherein each blind of said plurality of blinds includes two opposing elongated enclosure channels that receive and hold peripheral edges of said blind.

12. The sound absorbing composite blind system of claim 11 wherein said elongated enclosure channels are channels having cross-sections selected from the group consisting of three right angled sides and arcuated.

13. The sound absorbing composite blind system of claim 1 wherein said intermediate insulative absorptive layer has a thickness of about 0.15 inches to about 0.5 inches.

14. The sound absorbing composite blind system of claim 1 wherein said intermediate insulative absorptive layer has a density of about 4 pounds per cubic foot to about 9 pounds per cubic foot.

15. The sound absorbing composite blind system of claim 1 wherein said plurality of blinds are vertical blinds.

16. The sound absorbing composite blind system of claim 1 wherein said plurality of blinds are horizontal blinds.

17. The sound absorbing composite blind system of claim 1 wherein said blinds are angled blinds.

18. The sound absorbing composite blind system of claim 6 wherein said plurality of blinds are vertical blinds.

19. The sound absorbing composite blind system of claim 6 wherein said plurality of blinds are horizontal blinds.

20. The sound absorbing composite blind system of claim 6 wherein said blinds are angled blinds.
